(19) United States
(12) Patent Application Publication
(10) Pub. No.: US 2018/0300028 A1
(43) Pub. Date: Oct. 18, 2018

(54) SYSTEMS AND METHODS FOR DYNAMICALLY DETERMINING ACTIONS ASSOCIATED WITH A PAGE IN A SOCIAL NETWORKING SYSTEM

(71) Applicant: Facebook, Inc., Menlo Park, CA (US)

(72) Inventors: Neal Suresh Vora, San Jose, CA (US); Ameya Ajit Ranade, Sunnyvale, CA (US); John David Dripps, Menlo Park, CA (US); Chloe Jean Park, San Francisco, CA (US); Ross Breytberg, South San Francisco, CA (US)

(21) Appl. No.: 15/489,486

(22) Filed: Apr. 17, 2017

(51) Int. Cl. G06F 3/0483; G06F 3/0484

(52) U.S. Cl. CPC G06F 3/0483; G06F 3/0484

(57) ABSTRACT

Systems, methods, and non-transitory computer readable media can receive a request from a client for one or more actions associated with a page for a particular channel for a particular user. A plurality of actions associated with the page can be obtained. The plurality of actions can be ranked for the particular channel for the particular user based at least in part on a machine learning model. One or more actions from the ranking the plurality of actions can be provided to the client for rendering in a user interface.

### FIELD OF THE INVENTION

The present technology relates to the field of social networks. More particularly, the present technology relates to techniques for determining actions and other items for pages associated with social networking systems.

### BACKGROUND

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

The social networking system may provide pages for various entities. For example, pages may be associated with companies, businesses, brands, products, artists, public figures, entertainment, individuals, and other types of entities. Pages can be dedicated locations on the social networking system to reflect the presence of the entities on the social networking system. A page can provide various actions that users can take in connection with the page or an entity associated with the page.

### SUMMARY

Various embodiments of the present disclosure can include systems, methods, and non-transitory computer readable media configured to receive a request from a client for one or more actions associated with a page for a particular channel for a particular user. A plurality of actions associated with the page can be obtained. The plurality of actions can be ranked for the particular channel for the particular user based at least in part on a machine learning model. One or more actions from the ranking the plurality of actions can be provided to the client for rendering in a user interface.

In some embodiments, the plurality of actions associated with the page is specified in an entity definition of an entity associated with the page.

In certain embodiments, the entity definition is provided by an entity definition layer.

In an embodiment, the ranking the plurality of actions is based on one or more of: attributes associated with users, attributes associated with pages, engagement of users with actions, or a priority associated with actions.

In some embodiments, a channel includes one or more user interface (UI) elements for displaying one or more actions associated with the page.

In certain embodiments, the one or more UI elements include one or more of: a toolbar, a button, or a tab.

In an embodiment, the channel is identified by the one or more UI elements and one or more of: an operating system (OS), an application, or a surface.

In some embodiments, the one or more actions from the ranking the plurality of actions are provided to the client based on respective action objects, wherein the respective action objects include information for rendering corresponding actions in the user interface.

In certain embodiments, the particular user satisfies criteria for providing the one or more actions from the ranking the plurality of actions.

In an embodiment, the request includes one or more of: the particular user, the particular page, a location of the particular user, an action supported by the client, or an application installed on the client.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example pages action framework module configured to determine actions or other items associated with a page of an entity, according to an embodiment of the present disclosure.

FIG. 2A illustrates an example pages action module configured to determine actions or other items associated with a page for a particular channel, according to an embodiment of the present disclosure.

FIG. 2B illustrates an example action ranking module configured to rank actions or other items associated with a page for a particular channel, according to an embodiment of the present disclosure.

FIG. 3A illustrates an example first user interface for determining actions or other items associated with a page of an entity, according to an embodiment of the present disclosure.

FIG. 3B illustrates an example second user interface for determining actions or other items associated with a page of an entity, according to an embodiment of the present disclosure.

FIG. 4 illustrates an example first method for providing actions or other items associated with a page of an entity, according to an embodiment of the present disclosure.

FIG. 5 illustrates an example second method for providing actions or other items associated with a page of an entity, according to an embodiment of the present disclosure.

FIG. 6 illustrates a network diagram of an example system that can be utilized in various scenarios, according to an embodiment of the present disclosure.

FIG. 7 illustrates an example of a computer system that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

Dynamically Determining Actions Associated with a Page in a Social Networking System

People use computing devices (or systems) for a wide variety of purposes. Computing devices can provide different kinds of functionality. Users can utilize their computing devices to produce information, access information, and share information. In some cases, users can utilize computing devices to interact or engage with a conventional social networking system (e.g., a social networking service, a social network, etc.). A social networking system may provide user profiles for various users through which users may add connections, such as friends, or publish content items.

The social networking system may provide pages for various entities. For example, pages may be associated with companies, businesses, brands, products, artists, public figures, entertainment, individuals, and other types of entities. Pages can be dedicated locations on the social networking system to reflect the presence of the entities on the social networking system. A page can provide various actions that users can take in connection with the page or an entity associated with the page. Conventional approaches specifically arising in the realm of computer technology can provide one or more predetermined actions for all users, for example, without customization or personalization. For example, a page presented to all users may be static with respect to at least actions provided for the page.

An improved approach rooted in computer technology can overcome the foregoing and other disadvantages associated with conventional approaches specifically arising in the realm of computer technology. Based on computer technology, the disclosed technology can provide a platform that can dynamically determine one or more actions or other items to be provided to users in association with a page. The disclosed technology can determine actions or other items for users based on channels, user attributes, page attributes, actions or other items specified by administrators, priority of actions or other items specified by administrators, etc. Actions or other items for a page can be customized or personalized for a particular user when the page is presented to that user. An entity definition layer can be used to represent entities and specify entity definitions. An entity definition for an entity can specify actions and other items associated with the entity. Other items associated with an entity can include information, content, workflows, etc. A page of an entity can be presented based on the entity definition for the entity. Actions and other items for an entity can be ranked in order to determine actions that are relevant to a user. For example, machine learning techniques can be used to rank actions and other items. Actions and other items presented to a user in association with a page can vary for different channels. A channel can indicate any portion of a user interface through which actions or items can be provided. A channel can be distinguished by (or by types of) surfaces, platforms, applications, etc. Examples of channels can include a toolbar of a page in a mobile application, buttons of a page on the web, etc. A client can request actions or other items for a page for a particular channel from a server, and the server can determine and provide relevant actions or other items for the channel. Actions or other items can be provided using action objects. An action object can include information associated with an action or an item that can be used by the client to render the action or the item for the channel. For example, the action object can include information that is needed to display or execute an action or an item. In this manner, the disclosed technology can provide a representation of an entity that is customized or personalized for a user. Providing relevant actions for a user can lead to increased engagement with a page as well as the social networking system. In addition, use of the entity definition layer can provide flexibility in representing an entity. For example, actions and other content items can be changed as appropriate. Details relating to the disclosed technology are explained below.

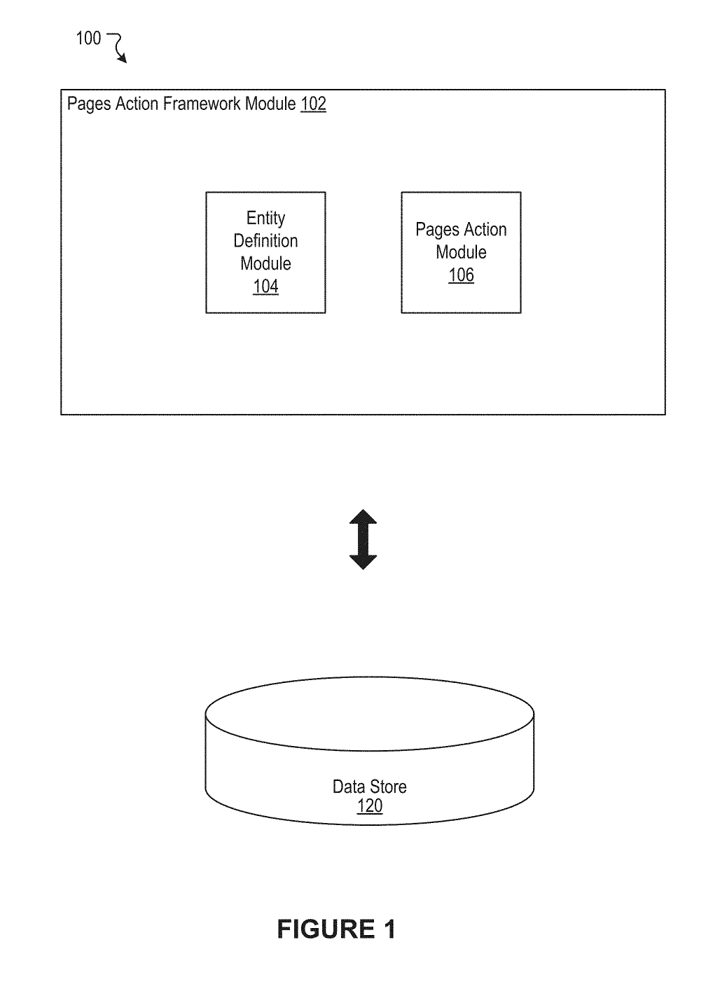

FIG. 1 illustrates an example system 100 including an example pages action framework module 102 configured to determine actions or other items associated with a page of an entity, according to an embodiment of the present disclosure. The pages action framework module 102 can include an entity definition module 104 and a pages action module 106. In some instances, the example system 100 can include at least one data store 120. The components (e.g., modules, elements, steps, blocks, etc.) shown in this figure and all figures herein are exemplary only, and other implementations may include additional, fewer, integrated, or different components. Some components may not be shown so as not to obscure relevant details. In various embodiments, one or more of the functionalities described in connection with the pages action framework module 102 can be implemented in any suitable combinations. For illustrative purposes, the disclosed technology is described in connection with a social networking system, but the disclosed technology can apply to any type of system.

The entity definition module 104 can specify an entity definition for an entity, for example, via an entity definition layer. An entity definition layer can be used to provide entity definitions for entities. For example, the entity definition layer can be used across various products and applications associated with the social networking system, and an entity definition can be used to select actions and/or other items to present to a user for a page of the entity. An entity definition for an entity can include various settings and/or parameters associated with the entity, and a page of the entity can be presented to users based on the entity definition. Accordingly, any changes to an entity definition of an entity can be reflected across various products and applications. The entity definition can include actions and/or other items associated with the entity, such as information, content, workflows, etc. An action can indicate any action that can be taken by a user in connection with a page or an entity of the page. Examples of actions can include like, save, share, follow, call, get directions, order, calls-to-action (CTAs), get a ride, get a coupon or discount, shop, donate, message, post, comment, etc. Actions can include default actions provided by the social networking system or actions created by administrators. An action can be associated with criteria for providing the action to a user. In some cases, such criteria may also be referred to as eligibility criteria. Information can indicate any information associated with an entity. Examples of information can include a description of an entity, operating hours associated with an entity, a map of a location associated with an entity, etc. Content can include any content associated with an entity. Examples of content can include photos, videos, audio, reviews, products, etc. In some embodiments, content associated with an entity can be represented as one or more tabs on a page of the entity. A workflow can indicate any workflow that can be provided in association with a page or an entity of the page. Examples of workflows can include an ordering workflow for ordering products, services, etc., a ticketing workflow for ordering tickets for events, etc. There can be associations between different settings and/or parameters associated with the entity. For example, the entity definition can include associations between actions and information, actions and content, actions and workflows, information and content, information and workflows, content and workflows, etc. Settings and/or parameters included in the entity definition of an entity can be presented via one or more channels associated with the social networking system. Channels are explained in more detail below. All examples herein are provided for illustrative purposes, and there can be many variations and other possibilities.

The pages action module 106 can determine actions or other items associated with a page for a particular channel. For example, the pages action module 106 can receive a request from a client for actions or other items for a particular channel for a user. The pages action module 106 can dynamically determine actions or other items for the user and return the determined actions or other items to the client. Functionality of the pages action module 106 is described in more detail herein. All examples herein are provided for illustrative purposes, and there can be many variations and other possibilities.

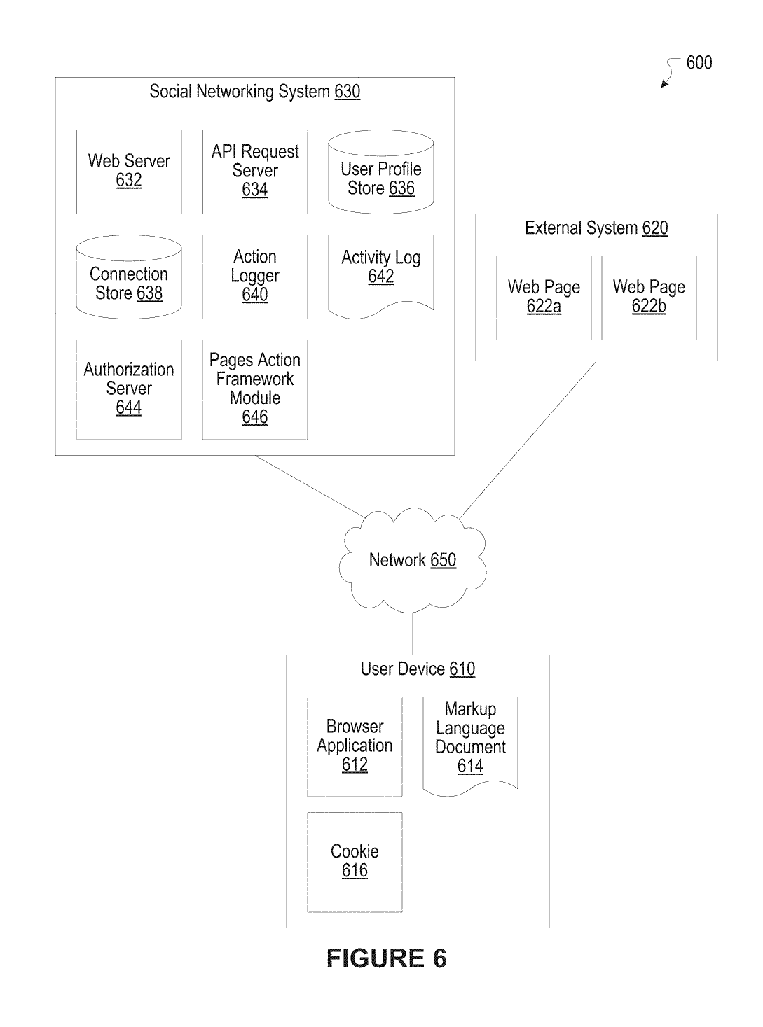

In some embodiments, the pages action framework module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the pages action framework module 102 can be, in part or in whole, implemented as software running on one or more computing devices or systems, such as on a server system or a client computing device. In some instances, the pages action framework module 102 can be, in part or in whole, implemented within or configured to operate in conjunction or be integrated with a social networking system (or service), such as a social networking system 630 of FIG. 6. Likewise, in some instances, the pages action framework module 102 can be, in part or in whole, implemented within or configured to operate in conjunction or be integrated with a client computing device, such as the user device 610 of FIG. 6. For example, the pages action framework module 102 can be implemented as or within a dedicated application (e.g., app), a program, or an applet running on a user computing device or client computing system. It should be understood that many variations are possible.

The data store 120 can be configured to store and maintain various types of data, such as the data relating to support of and operation of the pages action framework module 102. The data maintained by the data store 120 can include, for example, information relating to an entity definition layer, entity definitions, pages, actions and other items (e.g., information, content, workflows, etc.), associated with an entity or a page, machine learning models, rankings associated with actions and other items (e.g., information, content, workflows, etc.), channels, etc. The data store 120 also can maintain other information associated with a social networking system. The information associated with the social networking system can include data about users, social connections, social interactions, locations, geo-fenced areas, maps, places, events, groups, posts, communications, content, account settings, privacy settings, and a social graph. The social graph can reflect all entities of the social networking system and their interactions. As shown in the example system 100, the pages action framework module 102 can be configured to communicate and/or operate with the data store 120. In some embodiments, the data store 120 can be a data store within a client computing device. In some embodiments, the data store 120 can be a data store of a server system in communication with the client computing device.

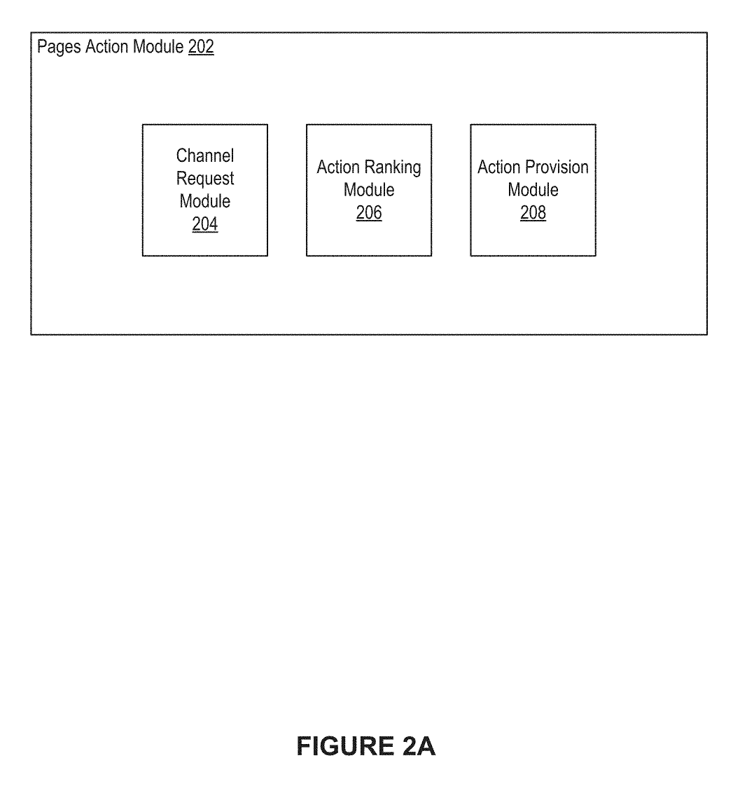

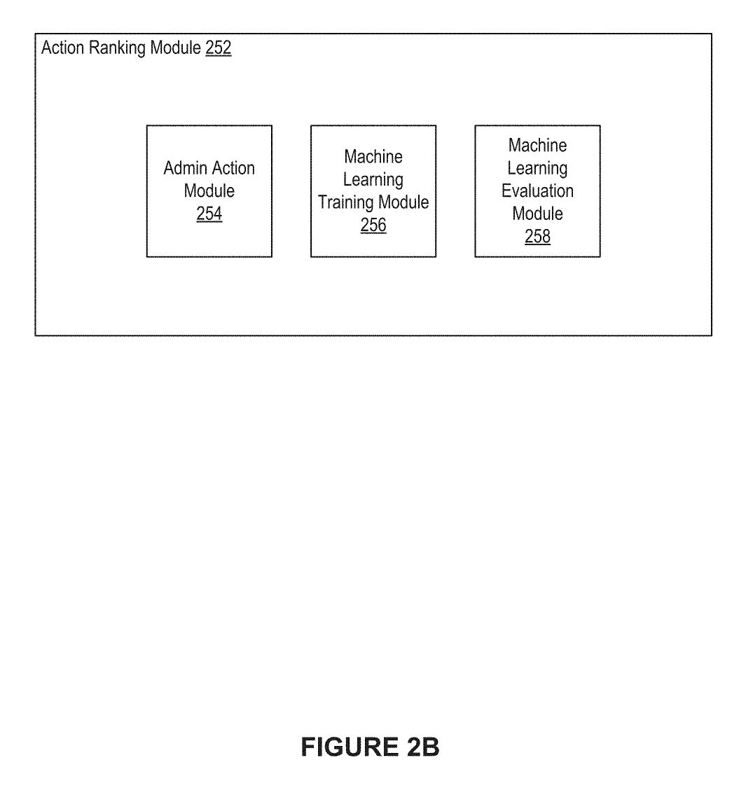

FIG. 2A illustrates an example pages action module 202 configured to determine actions or other items associated with a page for a particular channel, according to an embodiment of the present disclosure. In some embodiments, the pages action module 106 of FIG. 1 can be implemented with the example pages action module 202. As shown in the example of FIG. 2A, the example pages action module 202 can include a channel request module 204, an action ranking module 206, and an action provision module 208. The example pages action module 202 can be implemented as a part of a server. The server can be associated with a social networking system. The server can receive requests for actions or other items from one or more clients. For a request from a client, the server can determine one or more actions or other items for a page for a particular channel for a particular user. The server can send the determined actions or other items to the client. The actions or other items can be encapsulated in one or more action objects and sent to the client. The client can render the one or more actions in a user interface based on information included in the one or more action objects. Details relating to the example page action module 202, the server, and the client are explained below.

The channel request module 204 can receive requests from clients for actions or other items associated with pages for particular channels. Actions or other items associated with a page may vary across channels. A channel can indicate any portion or element of a user interface through which actions or other items can be provided. For example, a channel can include one or more user interface (UI) elements, such as a toolbar, buttons, tabs, etc. A channel can be distinguished by (or by a type of) surface, platform, application, etc. For example, a toolbar of a page can be considered as separate channels when provided via an application (e.g., a mobile application) versus when provided via the web. A channel may be specified or identified by a UI element (or a set of UI elements) and a surface, platform, and/or application. In some embodiments, a surface can indicate a computing environment, such as a mobile device, a desktop or laptop computer, etc. In some embodiments, a platform can indicate an operating system (OS), such as a personal computer OS, a mobile OS, etc. For instance, examples of channels can include a toolbar of a page in an application, a toolbar of a page on the web, buttons of a page in an application, buttons of a page on the web, tabs of a page in an application, tabs of a page on the web, etc. Channels can be distinguished based on surface, platform, or application (or a type of surface, platform, or application) since user behavior can vary based on the surface, platform, or application (or the type of surface, platform, or application). For example, users may be more likely to purchase products when accessing a page on the web than when accessing the page through a mobile application. Accordingly, as an example, a button for purchasing can be presented to a user for the page on the web, but a button for calling or another action can be presented to the user for the page in the mobile application. There can be many different types of applications, such as a social networking service application, a photo application, a messaging or chat application, etc. A page can include more than one channel.

A request from a client can include information that can be used by a server (e.g., the pages action module 202) to determine actions or other items for a page for a particular channel. For example, the request can include a particular channel, a page for which actions or other items are requested, a user associated with the request, etc. The request can also include any relevant attributes associated with the user and/or the client, such as a location of the user, applications installed on the client, actions supported by the client, etc. In some embodiments, functionalities associated with the server (e.g., the pages action module 202) can be implemented as web services or application programming interfaces (APIs). A contract may specify parameters to be received from a client and an output to be returned to the client.

The action ranking module 206 can rank actions or other items associated with a page for a particular channel. For example, the action ranking module 206 can rank actions associated with a page for a particular channel for a particular user based on various attributes. The action ranking module 206 can also rank other items associated with a page, such as information, content, and workflows, for a particular channel for a particular user based on various attributes. Functionality of the action ranking module 206 is described in more detail herein. All examples herein are provided for illustrative purposes, and there can be many variations and other possibilities.

The action provision module 208 can provide selected actions or other items associated with a page for a particular channel. For example, the action provision module 208 can provide a number of actions or items required by the particular channel. Selected actions or other items can be customized for a particular channel and for a particular user. Actions or other items can be provided using action objects. An action object can include information associated with an action or an item. For example, an action object can include all information necessary to render an action or an item in a user interface and enable the action or the item. Information associated with an action or an item can include or indicate what the action or the item is (e.g., name, type, etc.), an image or icon associated with the action or the item, a state associated with the action or the item, a link or workflow associated with the action or the item, information associated with executing the action or providing the item, etc. For example, an action can be to like a page, and the action object for the action can indicate that the action is “like,” include a thumbs-up image, and include a state of whether the user has liked the page or not. As another example, an action can be to get a ride, and the action object for the action can indicate that the action is to get a ride and indicate that a messenger or chat application should be launched when the action is selected by the user. An option to reserve a ride can be presented in the messenger application.

FIG. 2B illustrates an example action ranking module 252 configured to rank actions or other items associated with a page for a particular channel, according to an embodiment of the present disclosure. In some embodiments, the action ranking module 206 of FIG. 2A can be implemented with the example action ranking module 252. As shown in the example of FIG. 2B, the example action ranking module 252 can include admin action module 254, a machine learning training module 256, and a machine learning evaluation module 258. The action ranking module 252 can determine or rank actions or other items associated with a page or an entity associated with the page based on various features and/or priority of actions or other items specified by administrators.

The admin action module 254 can specify a priority of actions or other items associated with a page or an entity associated with the page. The priority of actions or other items can be indicated by an administrator associated with the page or the entity associated with the page. Actions or other items can include default actions or other items provided by a social networking system. Actions or other items can also include actions or other items created by an administrator. An administrator can specify a priority of default actions or other items as well as administrator-created actions or other items. The priority specified by an administrator can be used in determining or ranking actions or other items.

The machine learning training module 256 can train a machine learning model to rank actions or items for a page, based on training data that includes actions or other items associated with pages or entities associated with pages, channels for actions or other items, engagement of users with actions or other items, etc. Various features can be used in training the machine learning model. For example, features can be selected from user attributes, page attributes, action or item attributes, channel attributes, engagement attributes, etc. User attributes can include any attributes associated with users. Examples of user attributes can include a location (e.g., a country, state, county, city, etc.), an age, an age range, a gender, an interest, a device, an operating system (OS), etc. Page attributes can include any attributes associated with pages. Examples of page attributes can include a page category, whether a page has certain information (e.g., an address, a phone number, a website, etc.), etc. Action or item attributes can include any attributes relating to actions or other items associated with pages or entities associated with pages. Channel attributes can include any attributes relating to channels. Engagement attributes can include any attributes relating to user engagement with actions or other items. Weights associated with various features used to train the machine learning model can be determined. The machine learning model can be retrained based on new or updated training data. For example, if information about new pages, new users, and/or new actions or items becomes available, the machine learning training module 256 can train the machine learning model based on the information about new pages, new users, and/or new actions or items. The machine learning training module 256 can refine the machine learning model in order to achieve desired ranking results, for example, by retraining the machine learning model, adjusting features included in the machine learning model, etc. Engagement of users with actions or items can be measured and used to train or retrain the machine learning model, for example, as a part of the training data. In some cases, users can provide feedback relating to actions or items, and feedback by users can be used to train or retrain the machine learning model, for example, as a part of the training data.

The machine learning evaluation module 258 can apply the trained machine learning model to rank actions or items associated with a page for a particular channel for a particular user. Actions or items for a page can be ranked according to a likelihood of the user engaging with the actions or the items. The trained machine learning model can determine a score for each action for a page. The score for an action or an item can indicate or reflect a likelihood of the user engaging with the action of the item. Actions or items can be ordered according to the scores and can be provided to a client according to a number of actions or items required by the channel. For example, if the channel includes four buttons, four top-ranked actions or items can be provided for the channel. In some embodiments, a number of actions or items provided to the client can be more than the number of actions or items required by the channel, and extra actions or items can be accessible via a UI element for additional actions or items (e.g., a button, a tab, etc.). As discussed herein, an action or an item can be associated with criteria for providing the action or the item. Criteria for providing the action or the item can specify one or more conditions that should be satisfied for the action or the item to be provided to the user. Examples of criteria can include whether a page has certain information (e.g., an address, a phone number, a website, etc.), whether a user is within a required distance or at a required location, whether a required application is installed on a client, etc. For example, for “get a ride” action, the criteria can indicate that a page should have an address, a user should be local (e.g., within a predetermined proximity), and that a messenger or chat application should be installed on a client. Actions or items for which criteria are satisfied by the user or the channel can be provided to the user. In some cases, an administrator may have specified priority of actions or items. In such cases, the priority specified by the administrator can be considered in connection with ranked actions or items in order to determine which actions or items to provide for the user. In some embodiments, actions or items included in the priority specified by the administrator can have a higher priority than actions or items ranked by the machine learning model. In other embodiments, actions or items included in the priority specified by the administrator can be provided in combination with actions or items ranked by the machine learning model. In certain cases, not all of actions or items included in the priority specified by the administrator may be provided to the user. For example, the user may not satisfy criteria for providing an action included in the priority. As another example, if a difference between the score for an action included in the priority and the score for another action ranked by the machine learning model exceeds a threshold value, the other action with the higher score may be provided to the user. Many variations are possible.

In this manner, actions or items for a channel of a page can be customized for each user, and the disclosed technology can represent an entity associated with the page in a way that is best suited for that user. Administrators can also provide input relating to which actions are important to an entity or a page by specifying priority of actions or items. In addition, using a common entity definition across various products and platforms to represent an entity can provide flexibility in changing actions and other items associated with the entity. Any changes in the entity definition can be reflected appropriately across various channels.

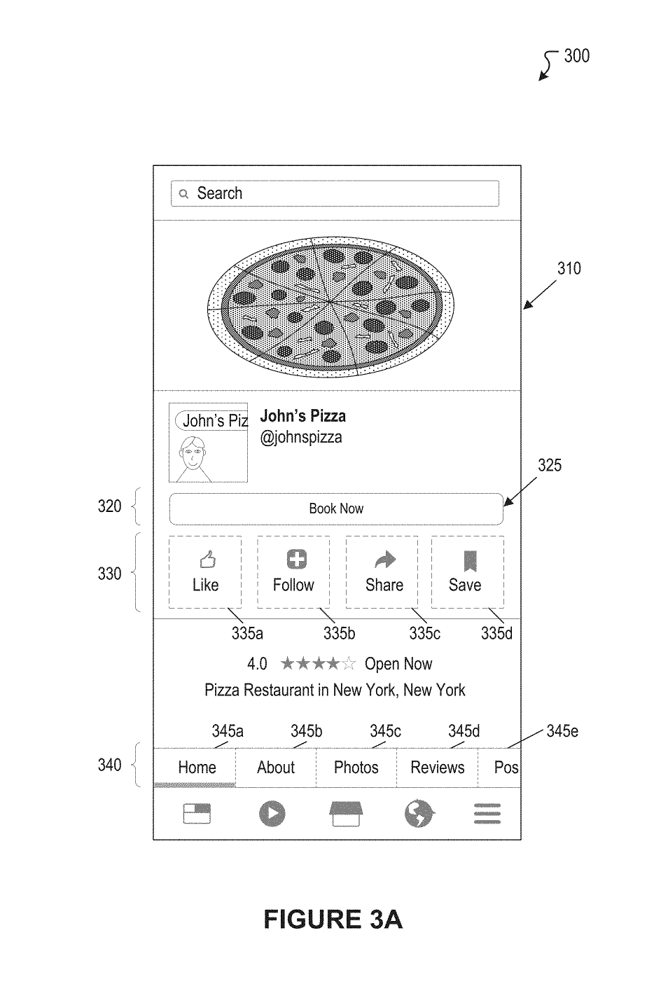

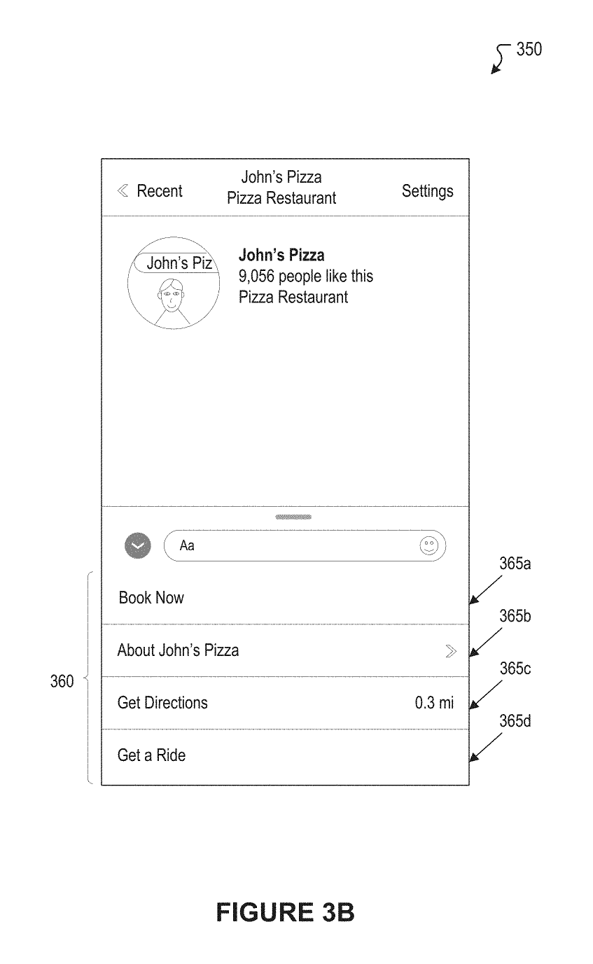

FIG. 3A illustrates an example first user interface 300 for providing actions or other items associated with a page of an entity, according to an embodiment of the present disclosure. The user interface 300 illustrates an example page 310 shown in a social networking mobile application. The page 310 includes three different channels 320, 330, 340 where actions or other items associated with the page can be provided. The channel 320 can include one or more primary buttons 325. In the example of FIG. 3A, the channel 320 includes one button 325, which can be a CTA button. The channel 330 is an action bar and includes one or more secondary buttons 335. In the example of FIG. 3A, the channel 330 includes four buttons: a button for liking the page 335a, a button for following the page 335b, a button for sharing the page 335c, and a button for saving the page 335c. For illustrative purposes, the buttons 335 are shown in FIG. 3A in dashed lines to delineate the buttons 335 from each other. Actions to be included in the channel 320 can be ranked for a specific user, as described above. For example, the button “Book Now” 325 can be a top-ranked action out of other actions, which are not shown in the channel 320. Similarly, actions to be included in the channel 330 can be ranked for a specific user. The channel 340 is a tab bar and includes one or more tabs 345. In the example of FIG. 3A, the channel 340 includes at least the following tabs: “Home” 345a, “About” 345b, “Photos” 345c, “Reviews” 345d, and “Posts” 345e. There can be additional tabs that can be shown when the tab bar is scrolled, for example, to the right. Tabs can relate to content associated with the page or the entity associated with the page. For example, different tabs can represent different content or different types of content. For illustrative purposes, the tabs 345 are shown in FIG. 3A with dashed lines to delineate the tabs 345 from each other. Content to be included in the channel 340 can be ranked for a specific user. In some embodiments, different content or different types of content can be considered as actions and ranked for a specific user as actions. Actions and content provided to the user for the page 310 can differ from the buttons 325, 335 and tabs 345 if the page 310 is provided in a different surface, platform, and/or application.

FIG. 3B illustrates an example second user interface 350 for providing actions or other items associated with a page of an entity, according to an embodiment of the present disclosure. FIG. 3B illustrates an example user interface 350 for a page in a messenger or chat application. The user interface 350 includes one channel 360 where actions or other items associated with the page can be provided. The channel 360 includes four menu items: “Book Now” 365a, “About John's Pizza” 365b, “Get Directions” 365c, and “Get a Ride” 365d. If a user selects a menu item 365, a corresponding action can be executed or performed. For example, the menu item “Book Now” 365a can present a user interface (e.g., a modal window) for making a reservation or can initiate a call to a phone number associated with the entity. As another example, the menu item “Get a Ride” 365d can present a user interface (e.g., a modal window) for reserving a ride, e.g., through a ride-sharing service. Actions to be included in the channel 360 can be ranked for a specific user, as described above.

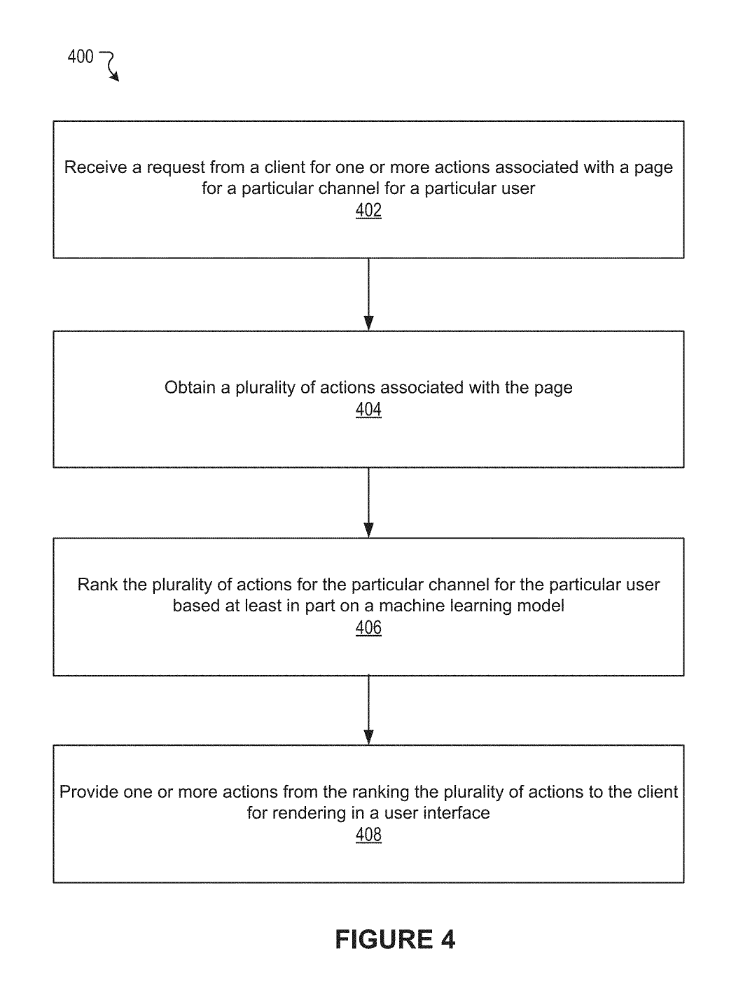

FIG. 4 illustrates an example first method 400 for determining actions or other items associated with a page of an entity, according to an embodiment of the present disclosure. It should be understood that there can be additional, fewer, or alternative steps performed in similar or alternative orders, or in parallel, based on the various features and embodiments discussed herein unless otherwise stated.

At block 402, the example method 400 can receive a request from a client for one or more actions associated with a page for a particular channel for a particular user. At block 404, the example method 400 can obtain a plurality of actions associated with the page. At block 406, the example method 400 can rank the plurality of actions for the particular channel for the particular user based at least in part on a machine learning model. At block 408, the example method 400 can provide one or more actions from the ranking the plurality of actions to the client for rendering in a user interface. Other suitable techniques that incorporate various features and embodiments of the present disclosure are possible.

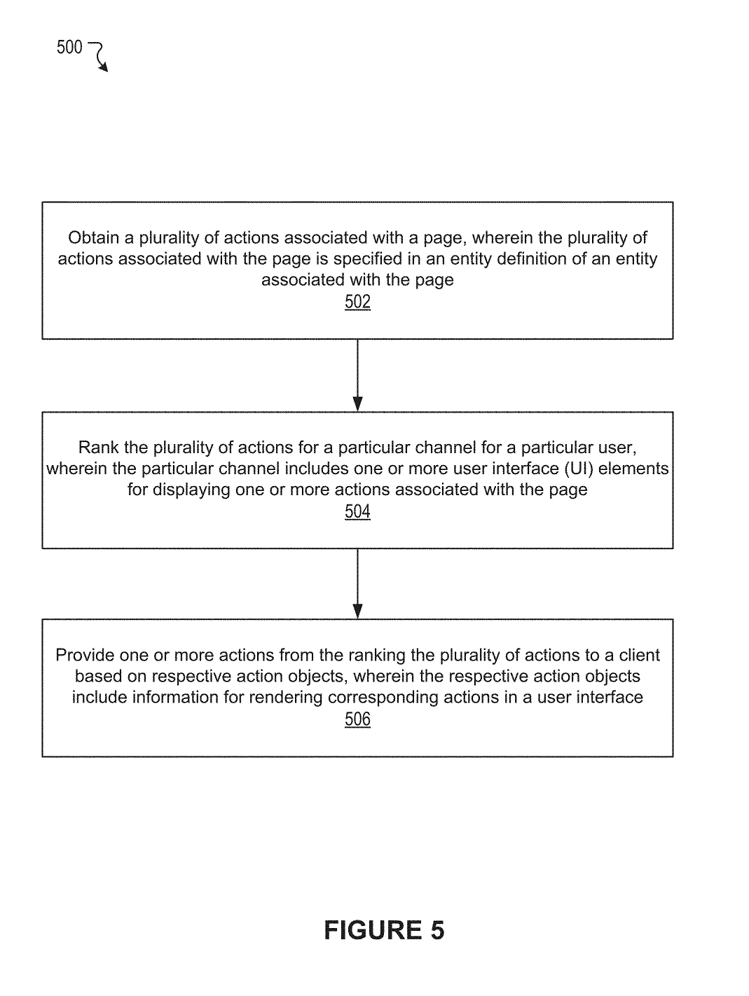

FIG. 5 illustrates an example second method 500 for determining actions or other items associated with a page of an entity, according to an embodiment of the present disclosure. It should be understood that there can be additional, fewer, or alternative steps performed in similar or alternative orders, or in parallel, based on the various features and embodiments discussed herein unless otherwise stated. Certain steps of the method 500 may be performed in combination with the example method 400 explained above.

At block 502, the example method 500 can obtain a plurality of actions associated with a page, wherein the plurality of actions associated with the page is specified in an entity definition of an entity associated with the page. The page can be similar to the page explained in connection with FIG. 4. At block 504, the example method 500 can rank the plurality of actions for a particular channel for a particular user, wherein the particular channel includes one or more user interface (UI) elements for displaying one or more actions associated with the page. At block 506, the example method 500 can provide one or more actions from the ranking the plurality of actions to a client based on respective action objects, wherein the respective action objects include information for rendering corresponding actions in a user interface. The client can be similar to the client explained in connection with FIG. 4. The user interface can be similar to the user interface explained in connection with FIG. 4. Other suitable techniques that incorporate various features and embodiments of the present disclosure are possible.

It is contemplated that there can be many other uses, applications, features, possibilities, and/or variations associated with various embodiments of the present disclosure. For example, users can, in some cases, choose whether or not to opt-in to utilize the disclosed technology. The disclosed technology can, for instance, also ensure that various privacy settings, preferences, and configurations are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, in accordance with an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include an pages action framework module 646. The pages action framework module 646 can be implemented with the pages action framework module 102, as discussed in more detail herein. In some embodiments, one or more functionalities of the pages action framework module 646 can be implemented in the user device 610.

### Hardware Implementation

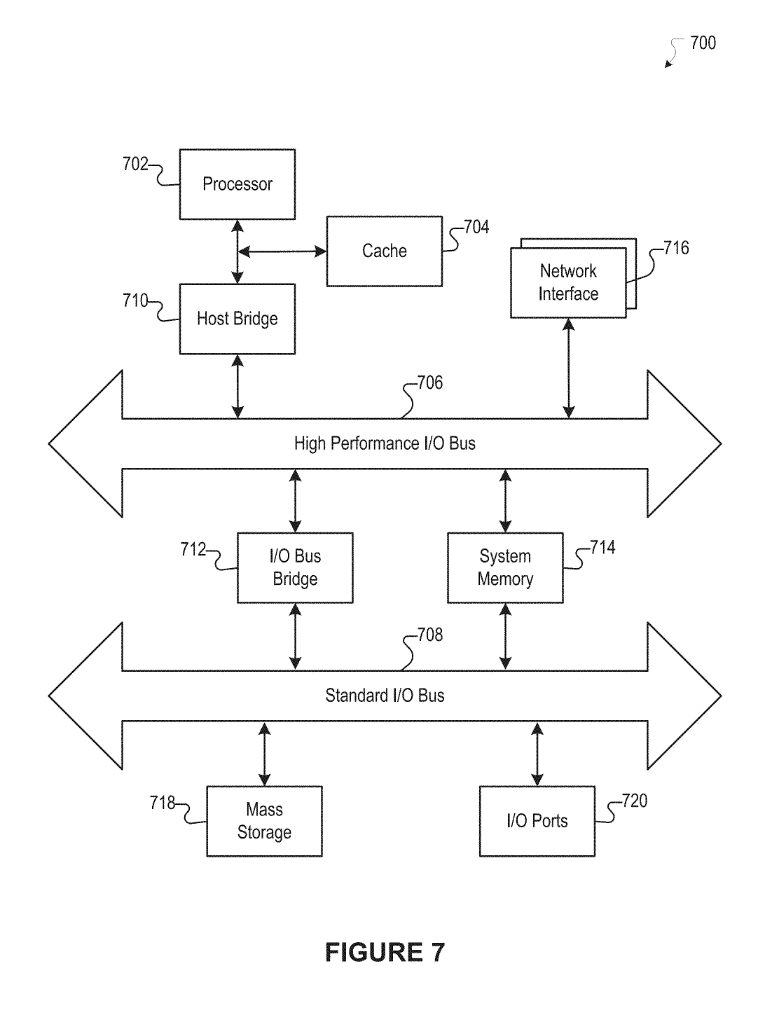

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
receiving, by a computing system, a request from a client for one or more actions associated with a page for a particular channel for a particular user;
obtaining, by the computing system, a plurality of actions associated with the page;
ranking, by the computing system, the plurality of actions for the particular channel for the particular user based at least in part on a machine learning model; and
providing, by the computing system, one or more actions from the ranking the plurality of actions to the client for rendering in a user interface.

2. The computer-implemented method of claim 1, wherein the plurality of actions associated with the page is specified in an entity definition of an entity associated with the page.

3. The computer-implemented method of claim 2, wherein the entity definition is provided by an entity definition layer.

4. The computer-implemented method of claim 1, wherein the ranking the plurality of actions is based on one or more of: attributes associated with users, attributes associated with pages, engagement of users with actions, or a priority associated with actions.

5. The computer-implemented method of claim 1, wherein a channel includes one or more user interface (UI) elements for displaying one or more actions associated with the page.

6. The computer-implemented method of claim 5, wherein the one or more UI elements include one or more of: a toolbar, a button, or a tab.

7. The computer-implemented method of claim 5, wherein the channel is identified by the one or more UI elements and one or more of: an operating system (OS), an application, or a surface.

8. The computer-implemented method of claim 1, wherein the one or more actions from the ranking the plurality of actions are provided to the client based on respective action objects, wherein the respective action objects include information for rendering corresponding actions in the user interface.

9. The computer-implemented method of claim 1, wherein the particular user satisfies criteria for providing the one or more actions from the ranking the plurality of actions.

10. The computer-implemented method of claim 1, wherein the request includes one or more of: the particular user, the particular page, a location of the particular user, an action supported by the client, or an application installed on the client.

11. A system comprising:
at least one hardware processor; and
a memory storing instructions that, when executed by the at least one processor, cause the system to perform:
receiving a request from a client for one or more actions associated with a page for a particular channel for a particular user;
obtaining a plurality of actions associated with the page;
ranking the plurality of actions for the particular channel for the particular user based at least in part on a machine learning model; and
providing one or more actions from the ranking the plurality of actions to the client for rendering in a user interface.

12. The system of claim 11, wherein the plurality of actions associated with the page is specified in an entity definition of an entity associated with the page.

13. The system of claim 11, wherein the ranking the plurality of actions is based on one or more of: attributes associated with users, attributes associated with pages, engagement of users with actions, or a priority associated with actions.

14. The system of claim 11, wherein a channel includes one or more user interface (UI) elements of the page for displaying one or more actions associated with the page.

15. The system of claim 14, wherein the channel is identified by the one or more UI elements and one or more of: an operating system (OS), an application, or a surface.

16. A non-transitory computer readable medium including instructions that, when executed by at least one hardware processor of a computing system, cause the computing system to perform a method comprising:
receiving a request from a client for one or more actions associated with a page for a particular channel for a particular user;
obtaining a plurality of actions associated with the page;
ranking the plurality of actions for the particular channel for the particular user based at least in part on a machine learning model; and
providing one or more actions from the ranking the plurality of actions to the client for rendering in a user interface.

17. The non-transitory computer readable medium of claim 16, wherein the plurality of actions associated with the page is specified in an entity definition of an entity associated with the page.

18. The non-transitory computer readable medium of claim 16, wherein the ranking the plurality of actions is based on one or more of: attributes associated with users, attributes associated with pages, engagement of users with actions, or a priority associated with actions.

19. The non-transitory computer readable medium of claim 16, wherein a channel includes one or more user interface (UI) elements of the page for displaying one or more actions associated with the page.

20. The non-transitory computer readable medium of claim 19, wherein the channel is identified by the one or more UI elements and one or more of: an operating system (OS), an application, or a surface.
